(19) United States
(12) Patent Application Publication
(10) Pub. No.: US 2015/0113101 A1
(43) Pub. Date: Apr. 23, 2015

(54) METHOD AND APPARATUS FOR PROVIDING STREAMING CONTENT

(71) Applicant: Electronics and Telecommunications Research Institute, Daejeon (KR)

(72) Inventors: Woo-Suk KIM, Daejeon (KR); Byungjun BAE, Daejeon (KR); Hun Hee LEE, Daejeon (KR); Hyoungsoo LIM, Daejeon (KR); Namho HUR, Sejong (KR)

(21) Appl. No.: 14/519,669

(22) Filed: Oct. 21, 2014

(30) Foreign Application Priority Data
Oct. 21, 2013 (KR) 10-2013-0125531
Oct. 13, 2014 (KR) 10-2014-0137946

(51) Int. Cl. H04L 29/06; G06F 17/30

(52) U.S. Cl. CPC H04L 65/60; G06F 17/30386
USPC 709/219

(57) ABSTRACT

A content provider provides content by receiving a request for streaming content from a user, determining whether a streaming file corresponding to the streaming content is stored in the content provider, and if the streaming file is stored in the content provider, providing the internal protocol (IP) address of the content provider to a web browser.

### CROSS-REFERENCE TO RELATED APPLICATION

This application claims priority to and the benefit of Korean Patent Application Nos. 10-2013-0125531 and 10-2014-0137946 filed in the Korean Intellectual Property Office on Oct. 21, 2013 and Oct. 13, 2014, the entire contents of which are incorporated herein by reference.

### BACKGROUND OF THE INVENTION

(a) Field of the Invention

The present invention relates to a method and apparatus for providing streaming content in a transparent way over a broadcast network.

(b) Description of the Related Art

Hybrid delivery in integrated broadcast and communication environments is a technology of transmitting the same or related content over broadcast and communication networks. Content is transmitted over either a broadcast network or a communication network or via both the broadcast network and the communication network, according to network conditions or user requirements, so that the utilization of network resources can be improved. Moreover, the integration of broadcast and communication networks allows transfer of content requiring wide bandwidth.

One of the technical challenges in hybrid delivery is to provide a method which enables a user or an application to access content transmitted over broadcast and communication networks in a consistent and transparent way. That is, users or applications on the content receiving end process content delivered over broadcast and communication networks through the same technical method. This reduces the complexity of application and facilitates the development of a variety of applications.

Hypertext transfer protocol (HTTP) streaming is a media streaming protocol which is the current mainstream of web environments. In HTTP streaming, unlike the conventional streaming protocols, media is split up into segments or chunks that are physically or virtually separable, and servers transmit them to UEs using the HTTP protocol.

The advantages of HTTP streaming are that it can apply the conventional web-based technology itself using the HTTP protocol, a standard for web environments, has high accessibility because it is rarely blocked by firewalls, and it does not require developing specific applications as web browsers can be used.

However, there are some problems to be overcome in order to provide HTTP streaming over a broadcast network. In the first place, content is conventionally transmitted in a stream in the conventional broadcasting protocols, whereas content is transmitted in a file format in HTTP streaming. Thus, it is necessary for a receiving end on a broadcast network to perform different data processing methods from the conventional methods. Moreover, the HTTP protocol is based on two-way communication, so it is hard to apply it directly to broadcast networks based on one-way communication.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for providing streaming content in a transparent way over a broadcast network.

According to an embodiment of the present invention, a streaming content provision method for a content provider is provided. The provision method may include: receiving a request for streaming content from a user; determining whether a streaming file corresponding to the streaming content is stored in the content provider; and if the streaming file is stored in the content provider, providing the internal protocol (IP) address of the content provider to a web browser.

The request may be in a uniform resource locator (URL) form.

The provision method may further include: receiving at least one streaming file and the URL of the at least one streaming file over a broadcast network; and storing the at least one streaming file based on the URL.

The storing may include storing the at least one streaming file in the same hierarchical structure as reflected in the URL of the streaming server.

The storing may include: creating the same directory as that of the streaming server in local storage of the content provider; and storing the streaming file in the directory created in the local storage.

The at least one streaming file may include media segments of the at least one streaming file and a metadata file for playing the at least one streaming file.

The provision method may further include analyzing the URL of the at least one streaming file and storing the domain name of at least one streaming server that has transmitted the at least one streaming file.

The determining may include comparing the domain name of the at least one streaming server with the domain name specified in the request.

Another embodiment of the present invention provides a content provider for providing streaming content. The content provider may include: a web browser that receives a request for streaming content from a user; and a domain name server (DNS) proxy that determines whether a streaming file corresponding to the streaming content is stored in the content provider, and if the streaming file is stored in the content provider, provides the internal protocol (IP) address of the content provider to the web browser.

The request may be in a uniform resource locator (URL) form.

The content provider may further include: a broadcast receiver that receives at least one streaming file and the URL of the at least one streaming file over a broadcast network; and a controller that stores the at least one streaming file in local storage based on the URL.

The controller may store the at least one streaming file in the local storage in the same hierarchical structure as reflected in the URL of the streaming server.

The controller may create the same directory as that of the streaming server in the local storage of the content provider, and stores the streaming file in the directory created in the local storage.

The at least one streaming file may include media segments of the at least one streaming file and a metadata file for playing the at least one streaming file.

The DNS proxy may analyze the URL of the at least one streaming file and stores the domain name of at least one streaming server that has transmitted the at least one streaming file.

The DNS proxy may compare the domain name of the at least one streaming server with the domain name specified in the request.

### BRIEF DESCRIPTION OF THE DRAWINGS

FIG. 1 is a view showing an integrated broadcast and communication system which provides HTTP streaming service according to an exemplary embodiment of the present invention.

FIG. 2 is a block diagram showing a content provider in the integrated broadcast and communication system according to the exemplary embodiment of the present invention.

FIG. 3 is a view showing a media segment file stored in the content provider according to the exemplary embodiment of the present invention.

FIG. 4 is a flowchart showing a content provision method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

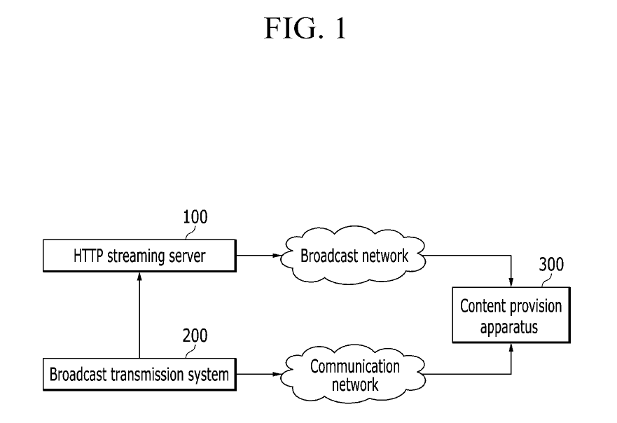

FIG. 1 is a view showing an integrated broadcast and communication system which provides HTTP streaming service according to an exemplary embodiment of the present invention.

Referring to FIG. 1, an integrated broadcast and communication system according to an exemplary embodiment of the present invention includes an HTTP streaming server 100, a broadcast transmission system 200, and a content provider 300.

The HTTP streaming server 100 provides an HTTP streaming service to the content provider 300 over a communication network, and transmits a media segment file to the broadcast transmission system 200. That is, the HTTP streaming server 100 provides the HTTP streaming service over a communication network (the web), and transmits the media segment file and related meta information to the broadcast transmission system 200.

The broadcast transmission system 200 can provide the HTTP streaming service to the content provider 300 by transmitting the media segment file received from the HTTP streaming server 100 to the content provider 300 over a broadcast network. Hereupon, the broadcast transmission system 200 multiplexes the media segment file and related metadata received from the HTTP streaming server 100, and then transmits them to the content provider 300 over the broadcast network. The media segment file to be transmitted over the broadcast network includes media segments of the media segment file and a metadata file (e.g., m3u8 format of Apple's Live Streaming or mpd format of DASH) for playing the media segment file.

Moreover, the broadcast transmission system 200 may additionally transmit uniform resource locator (URL) information of the media segment file to the content provider 300. For example, when the HTTP streaming server 100 transmits a media segment file accessible via URL “http://server.com/video/segment1.ts” to the broadcast transmission system 200, the broadcast transmission system 200 may transmit URL information of the media segment file, along with the media segment file, to the content provider 300.

The content provider 300 can receive the media segment file over a broadcast network and a communication network, and upon a request from the user, can provide the HTTP streaming service to the user.

In an exemplary embodiment of the present invention, the File Delivery over Unidirectional Transport (FLUTE) protocol can be used to transmit a media segment file over a broadcast network, but the transport protocol is not limited to this particular protocol as long as a means for restoring the media segment file received by the content provider 300 to its original form is provided.

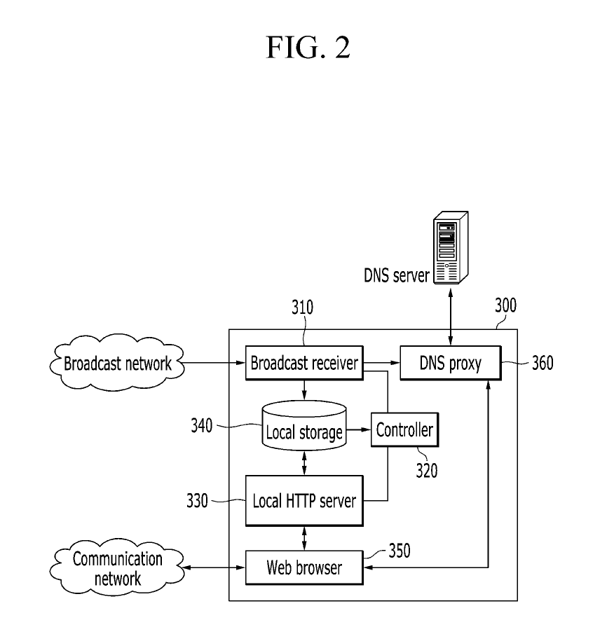

FIG. 2 is a block diagram showing a content provider in the integrated broadcast and communication system according to the exemplary embodiment of the present invention.

Referring to FIG. 2, the content provider according to the exemplary embodiment of the present invention includes a broadcast receiver 310, a controller 320, a local HTTP server 330, local storage 340, a web browser 350, and a domain name server (DNS) proxy 360.

The broadcast receiver 310 receives a media segment file from the broadcast transmission system 100 over a broadcast network. In this case, the broadcast receiver 310 may receive the URL of the media segment file as well and transmit the URL of the media segment file to the DNS proxy 360.

The controller 320 may store the media segment file in the local storage 340 connected to the local HTTP server 330.

The local HTTP server 330 may access the media segment file stored in the local storage 340 through the HTTP protocol.

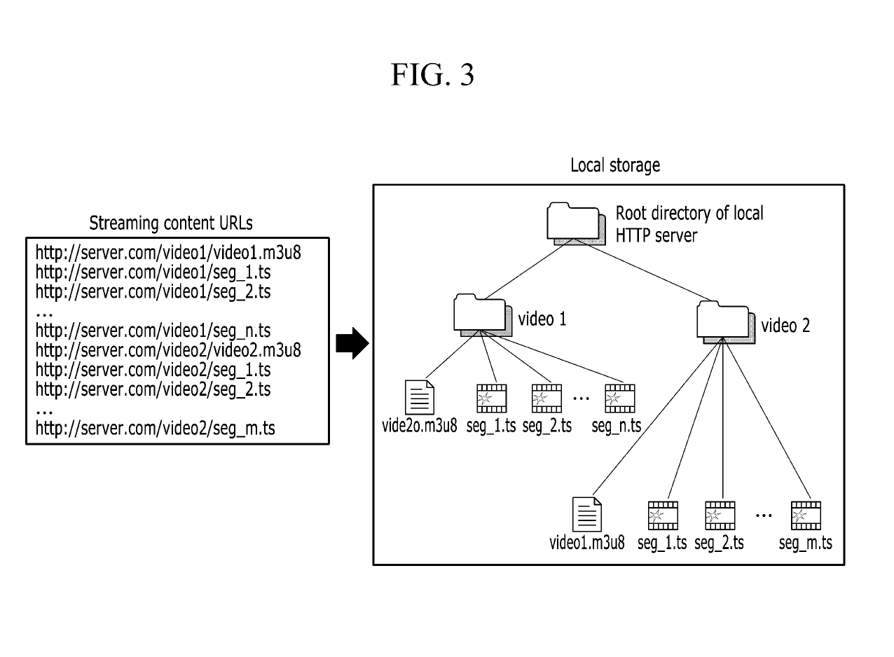

The media segment file received over the broadcast network may be stored in the local storage 340 in the same hierarchical structure as a media segment file delivered over a communication network. A method for the controller 320 to store a media segment file received over a broadcast network in the local storage 340 will be described in detail below with reference to FIG. 3.

The web browser 350 receives a request for a media segment file from the user through a URC, etc., and inquires of the DNS proxy 360 about the internet protocol (IP) address of the media segment file. Afterwards, HTTP streaming service can be provided to the user by using the IP address received from the DNS proxy 360.

The DNS proxy 360 analyzes the URL of the media segment file and stores the domain name of the HTTP streaming server of the media segment file. Afterwards, upon receiving an inquiry from the web browser 350 about the IP address of the requested media segment file, the DNX proxy 360 determines whether the requested media segment file can be delivered by the content provider 300 or whether it should be delivered from the HTTP streaming server 100 over a communication network. That is, the DNS proxy 360 can determine whether the requested media segment file can be delivered by the content provider 300.

FIG. 3 is a view showing a media segment file stored in the content provider according to the exemplary embodiment of the present invention.

The controller 320 stores HTTP-streaming related data, i.e., media segments and a metadata file, out of the broadcast data received through the broadcast receiver 310, in the local storage 340. In this case, the controller 320 stores the media segments and the metadata file in the local storage 340 in the same hierarchical structure as the file storage structure of the HTTP streaming server 100, with reference to the URL information received together with the media segment file. Then, the DNS proxy 360 may analyze the URL of the media segment file received from the broadcast receiver 310 and store the domain name of the HTTP streaming server 100 that first transmitted the media segment file.

For example, if the domain name of the HTTP streaming server 100 connected over a communication network is “server.com” and the media segments and metadata file of the media segment file are present in the “video1” and “video2” directories included in the root of “server.com”, respectively, the URLs of the media segment file are “http://server.com/video1/file_name” and “http://server.com/video2/file_name”. The controller 320 can also store the media segments and the metadata file in the local storage 340 in the same hierarchical structure, based on the URL information as above.

That is, the controller 320 creates “video1” and “video2” directories in the root directory of the local HTTP server 330, and stores the media segments and metadata file of the media segment file in the created directories, respectively. The media segments and metadata file of the media segment file can be actually stored in the local storage 340.

Afterwards, when the web browser 350 inquires about the IP address corresponding to the domain name specified in the URL, the DNS proxy 360 may provide the web browser 350 with the local IP address of the content provider 300 as the IP address of the media segment file, and the web browser 350 may access the media segment file received over a broadcast network in the same manner as it accesses the HTP streaming server 100.

For example, when the web browser 350 inquires about the IP address of the domain name specified in the URL the user has typed, the DNX proxy 360 determines whether a media segment file with the same domain name is stored in the content provider 300. If any media segment file with the same domain name is stored in the content provider 300, the DNS proxy 360 provides the local IP address “127.0.0.1” to the web browser 350. Thereafter, the web browser 350 connects to “127.0.0.1” and provides HTTP streaming service to the user.

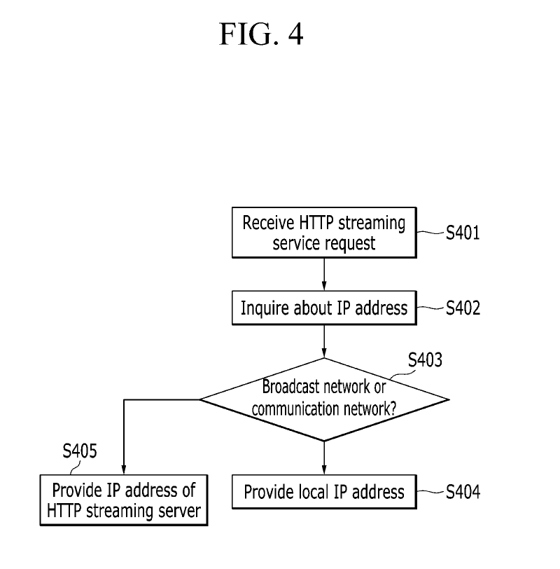

FIG. 4 is a flowchart showing a content provision method according to an exemplary embodiment of the present invention.

A method for providing HTTP streaming service upon a user request will be described as follows.

The user requests HTTP streaming service by, for example, typing a URL in the web browser 350 of the content provider 300 (S401).

Having received the user's request, the web browser 350 provides the domain name specified in the URL to the DNS proxy 360, in order to get the IP address of a media segment file (S402).

The DNS proxy 360 searches for the domain name of the media segment file obtained in the media segment file receiving step, and checks whether the media segment file requested by the user can be transmitted over a communication network or a broadcast network (S403). That is, the DNS proxy 360 compares the domain name of the URL the user has typed with the domain name of the media segment file obtained in the media segment file receiving step.

If the media segment file requested by the user is a file stored in the content provider 300, the DNS proxy 360 provides the local IP address of the content provider 300 to the web browser 350 (S404). That is, in the exemplary embodiment of the present invention, the DNS proxy 360 is able to provide the local IP address of the content provider 300 to the web browser 350 without having to obtain the URL address for the domain name because the media segment file is stored in the local storage 340 in the same hierarchical structure as the HTTP streaming server 100.

On the other hand, if the media segment file requested by the user is a file stored in the HTTP streaming server 100, the DNS proxy 360 provides the IP address of the HTTP streaming server 100 to the web browser 350 (S405). Hereupon, the DNS proxy 360 can obtain the IP address of the HTTP streaming server 100 through an external DNS server.

As seen above, according to an exemplary embodiment of the present invention, the content provider is able to provide the user with a file transmitted over a broadcast network, like it does over a communication network, by storing a media segment file received over a broadcast network in the same hierarchical structure as the HTTP streaming server 100.

While an exemplary embodiment of the present invention has been described in detail, the protection scope of the present invention is not limited to the foregoing embodiment and it will be appreciated by those skilled in the art that various modifications and improvements using the basic concept of the present invention defined in the appended claims are also included in the protection scope of the present invention.

What is claimed is:

1. A streaming content provision method for a content provider, the method comprising:
receiving a request for streaming content from a user;
determining whether a streaming file corresponding to the streaming content is stored in the content provider; and
if the streaming file is stored in the content provider, providing the internal protocol (IP) address of the content provider to a web browser.

2. The method of claim 1, wherein the request is in a uniform resource locator (URL) form.

3. The method of claim 1, further comprising:
receiving at least one streaming file and the URL of the at least one streaming file over a broadcast network; and
storing the at least one streaming file based on the URL.

4. The method of claim 3, wherein the storing comprises storing the at least one streaming file in the same hierarchical structure as reflected in the URL of the streaming server.

5. The method of claim 4, wherein
the storing comprises:
creating the same directory as that of the streaming server in local storage of the content provider; and
storing the streaming file in the directory created in the local storage.

6. The method of claim 3, wherein the at least one streaming file comprises media segments of the at least one streaming file and a metadata file for playing the at least one streaming file.

7. The method of claim 3, further comprising analyzing the URL of the at least one streaming file and storing the domain name of at least one streaming server that has transmitted the at least one streaming file.

8. The method of claim 7, wherein the determining comprises comparing the domain name of the at least one streaming server with the domain name specified in the request.

9. A content provider for providing streaming content, the apparatus comprising:
a web browser that receives a request for streaming content from a user; and
a domain name server (DNS) proxy that determines whether a streaming file corresponding to the streaming content is stored in the content provider, and if the streaming file is stored in the content provider, provides the internal protocol (IP) address of the content provider to the web browser.

10. The apparatus of claim 9, wherein the request is in a uniform resource locator (URL) form.

11. The apparatus of claim 9, further comprising:
a broadcast receiver that receives at least one streaming file and the URL of the at least one streaming file over a broadcast network; and
a controller that stores the at least one streaming file in local storage based on the URL.

12. The apparatus of claim 11, wherein the controller stores the at least one streaming file in the local storage in the same hierarchical structure as reflected in the URL of the streaming server.

13. The apparatus of claim 12, wherein the controller creates the same directory as that of the streaming server in the local storage of the content provider, and stores the streaming file in the directory created in the local storage.

14. The apparatus of claim 11, wherein the at least one streaming file comprises media segments of the at least one streaming file and a metadata file for playing the at least one streaming file.

15. The apparatus of claim 11, wherein the DNS proxy analyzes the URL of the at least one streaming file and stores the domain name of at least one streaming server that has transmitted the at least one streaming file.

16. The apparatus of claim 15, wherein the DNS proxy compares the domain name of the at least one streaming server with the domain name specified in the request.
